(19) United States
(12) Patent Application Publication
(10) Pub. No.: US 2007/0184336 A1
(43) Pub. Date: Aug. 9, 2007

(54) Membrane electrode assembly for fuel cell, method of preparing the same, and fuel cell using the membrane electrode assembly for fuel cell

(75) Inventors: Ji-rae Kim, Seoul (KR); Seung-jae Lee, Seongnam-si (KR); Jun-young Park, Seongnam-si (KR); Hae-kwon Yoon, Suwon-si (KR); Joon-hyung Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/444,320

(22) Filed: Jun. 1, 2006

(30) Foreign Application Priority Data
Feb. 7, 2006 (KR) 2006-11833

(51) Int. Cl. H01M 4/94; H01M 4/88

(52) U.S. Cl. 429/44; 429/42; 502/101

(57) ABSTRACT

A membrane electrode assembly for a fuel cell, a method of preparing the same, and a fuel cell using the membrane electrode assembly for a fuel cell. The membrane electrode assembly includes an anode comprising an anode substrate, an anode diffusion layer, and an anode catalyst layer having pores; a cathode comprising a cathode substrate, a cathode diffusion layer, and a cathode catalyst layer having pores; and an electrolyte membrane interposed between the cathode and the anode, wherein the anode diffusion layer is hydrophilic and the cathode diffusion layer is hydrophobic, and the average diameter of the pores of the anode catalyst layer is smaller than the average diameter of the pores of the cathode catalyst layer. In the membrane electrode assembly, air can be easily supplied to the cathode and water can easily flow out of the cathode, thereby obtaining high performance of the membrane electrode assembly, and the anode catalyst layer has relatively small pores, thereby improving durability of the anode and reducing the diffusion speed of methanol in the anode catalyst layer to maintain the initial performance of a battery for a long time.

### CROSS-REFERENCE TO RELATED PATENT APPLICATIONS

This application claims the benefit of Korean Application No. 2006-11833, filed Feb. 7, 2006, in the Korean Intellectual Property Office, the disclosure of which is incorporated herein by reference.

### BACKGROUND OF THE INVENTION

1. Field of the Invention

Aspects of the present invention relate to a membrane electrode assembly for a fuel cell, a method of preparing the same, and a fuel cell using the membrane electrode assembly. More particularly, aspects of the present invention relate to a membrane electrode assembly in which air can be easily supplied to a cathode and water can easily flow out of the cathode, thereby obtaining high performance of the membrane electrode assembly; and in which an anode catalyst layer has relatively small pores, thereby obtaining high durability of an anode and reducing the diffusion speed of methanol in the anode catalyst layer to maintain the initial performance of a battery for a long time. Aspects of the present invention further relate to a method of preparing the membrane electrode assembly and a fuel cell including the membrane electrode assembly.

2. Description of the Related Art

Fuel cells are a type of a power generating system that directly converts chemical reaction energy of hydrogen contained in hydrocarbons, such as methanol, ethanol, and natural gas, and oxygen into electrical energy. Fuel cells can be categorized into active fuel cell systems that use an external fuel supplier, such as a pump or a compressor, to supply fuel, such as methanol, and air; passive fuel cell systems in which no external pressing device is used and fuel is not actively supplied; and semi passive fuel cell systems, which are hybrids of active fuel cell systems and passive fuel cell systems.

In a fuel cell system, a fuel cell stack, which substantially generates electrical power, has a stacked structure consisting of a few to tens of unit cells, each of which includes a membrane electrode assembly (MEA) and a separator or bipolar plate. The MEA includes an anode and a cathode that are closely combined together, and a polymer electrolyte membrane interposed between the anode and the cathode.

FIG. 1 is a schematic sectional view of a conventional membrane electrode assembly. The conventional MEA will now be described in detail with reference to FIG. 1. An electrolyte membrane 50 is interposed between a cathode 20 and an anode 10. The anode 10 and the cathode 20 include catalyst layers 16 and 26, diffusion layers 14 and 24, and substrates 12 and 22, respectively.

The catalyst layers 16 and 26, in which an oxidation/reduction reaction occurs, are formed using a supported catalyst. The diffusion layers 14 and 24 support the anode 10 and the cathode 20 of the conventional MEA, and diffuse reactants to the catalyst layers 16 and 26 so that the reactants can easily reach the catalyst layers 16 and 26. The supports 12 and 22 can be formed of carbon cloth, carbon paper, etc. In general, the support 12 of the anode 10 does not include a binder, but the support 22 of the cathode 20 does include a binder.

The electrolyte membrane 50 allows protons generated in the anode 10 to flow to the cathode 20, but does not allow electrons generated in the cathode 20 to flow from the cathode 20 to the anode 10. The electrolyte membrane 50 further acts as a separator preventing the flow of unreacted hydrogen to the cathode 20 and the flow of unreacted oxidant to the anode 10.

However, when the flow of the oxidant in the cathode of a conventional MEA is insufficient, water generated in the cathode is not sufficiently removed, and thus, pores of the support become blocked. This phenomenon is referred to as “flooding.” Flooding of a fuel cell should be prevented. In order to remove water and thus prevent flooding, a carbonaceous support can include a binder having a water repelling property. In this case, however, the current collecting properties of a battery decrease in comparison to a battery in which a binder having a water repelling property is not used.

Also, in the case of an anode of a conventional MEA, the anode can be degraded by methanol, and thus, the durability of the anode can decrease over time. When this happens, methanol crossover can occur, since methanol can flow through pores of the anode more easily when the anode has deteriorated. Then, it becomes difficult to obtain the same electrode performance as prior to the deterioration.

### SUMMARY OF THE INVENTION

Aspects of the present invention provide a membrane electrode assembly in which air can be easily supplied to a cathode and water easily flow out of the cathode, thereby obtaining high performance of the membrane electrode assembly; and an anode catalyst layer has relatively small pores, thereby obtaining high durability of an anode and reducing the diffusion speed of methanol in the anode catalyst layer to maintain the initial performance of a battery for a long time, a method of preparing the same, and a fuel cell including the membrane electrode assembly.

According to an aspect of the present invention, there is provided a membrane electrode assembly including: an anode including an anode substrate, an anode diffusion layer, and an anode catalyst layer having pores; a cathode including a cathode substrate, a cathode diffusion layer, and a cathode catalyst layer having pores; and an electrolyte membrane interposed between the cathode and the anode, wherein the anode diffusion layer is hydrophilic and the cathode diffusion layer is hydrophobic, and the average diameter of pores of the anode catalyst layer is smaller than the average diameter of pores of the cathode catalyst layer.

According to another aspect of the present invention, there is provided a method of preparing a membrane electrode assembly, the method including: preparing an anode diffusion layer unit by coating a mixture of carbon powder, a binder, and a diffusion medium on an anode substrate and sintering the coated mixture; preparing an anode catalyst coated membrane by coating a mixture of a supported catalyst, a conductive material, and a diffusion medium on a transfer film, drying the coated mixture, and transferring the dried mixture onto an electrolyte membrane; preparing a cathode diffusion layer unit by coating a mixture of carbon powder, a binder, and a diffusion medium on a cathode substrate and sintering the coated mixture; preparing a cathode unit by coating a mixture of a supported catalyst, a conductive material, and a diffusion medium on the cathode diffusion layer unit and drying the coated mixture; and hot pressing the anode diffusion layer unit, anode catalyst coated membrane and the cathode unit together such that the anode catalyst coated membrane is combined with the cathode unit and the membrane electrode unit is formed.

According to yet another aspect of the present invention, there is provided a fuel cell including the membrane electrode assembly.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic sectional view of a conventional membrane electrode assembly;

FIG. 2 is a schematic sectional view of a membrane electrode assembly according to an embodiment of the present invention;

FIG. 3 is a flowchart illustrating a method of preparing a membrane electrode assembly according to an embodiment of the present invention;

FIG. 4 is a schematic sectional view of a membrane electrode assembly according to comparative example 1;

FIG. 5 is a schematic sectional view of a membrane electrode assembly according to comparative example 2;

FIG. 6 is a graph of power density with respect to time of unit cells using the membrane electrode assemblies prepared according to example 1 and comparative examples 1 and 2; and

FIG. 7 is a graph of current density with respect to time of unit cells using the membrane electrode assemblies prepared according to example 1 and comparative examples 1 and 2.

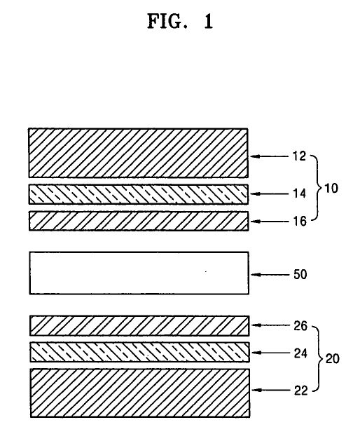

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A membrane electrode assembly according to an embodiment of the present invention includes: an anode including an anode substrate, an anode diffusion layer, and an anode catalyst layer having pores; a cathode including a cathode substrate, a cathode diffusion layer, and a cathode catalyst layer having pores; and an electrolyte membrane interposed between the cathode and the anode. The anode diffusion layer is hydrophilic and the cathode diffusion layer is hydrophobic, and the average diameter of the pores of the anode catalyst layer is smaller than the average diameter of the pores of the cathode catalyst layer.

According to the embodiment of the present invention, as described above, the anode diffusion layer is hydrophilic and the cathode diffusion layer is hydrophobic. As a result, air can be easily supplied to the cathode and water can easily flow from the cathode. In addition, since the average diameter of the pores of the anode catalyst layer is smaller than the average diameter of the pores of the cathode catalyst layer, an easy supply of air to the cathode and easy discharge of water from the cathode can be obtained, the durability of the anode is increased, and the diffusion speed of methanol in the anode is reduced.

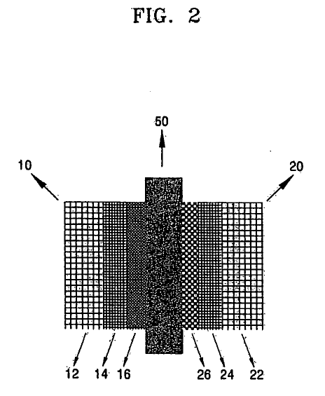

FIG. 2 is a schematic sectional view of a membrane electrode assembly according to an embodiment of the present invention. Referring to FIG. 2, an anode diffusion layer 14 is more hydrophilic than a cathode diffusion layer 24, and the average diameter of pores of an anode catalyst layer 16 is smaller than the average diameter of pores of a cathode catalyst layer 26.

In order to obtain such characteristics described above, the anode diffusion layer 14 may contain 5-20 wt % of polytetrafluoroethylene, and the cathode diffusion layer 24 may contain 20-50 wt % of polytetrafluoroethylene.

The average diameter of pores may be in the range of 3-5 nm for the anode catalyst layer 16, and may be in the range of 10-50 nm for the cathode catalyst layer 26.

The surface area per unit mass may be in the range of 15-25 m²/g for the anode catalyst layer 16, and may be in the range of 2-10 m²/g for the cathode catalyst layer 26.

The membrane electrode assembly can be prepared using the following method, the method including: preparing an anode diffusion layer unit by coating a mixture of a carbon powder, a binder, and a diffusion medium on an anode substrate and sintering the coated mixture; preparing an anode catalyst coated membrane by coating a mixture of a supported catalyst, a conductive material, and a diffusion medium on a transfer film, drying the coated mixture, and transferring the dried mixture onto an electrolyte membrane; preparing a cathode diffusion layer unit by coating a mixture of a carbon powder, a binder, and a diffusion medium on a cathode substrate and sintering the coated mixture; preparing a cathode unit by coating a mixture of a supported catalyst, a conductive material, and a diffusion medium on the cathode diffusion layer unit and drying the coated mixture; and hot pressing the anode catalyst coated membrane and the cathode unit such that the anode catalyst coated membrane is combined with the cathode unit.

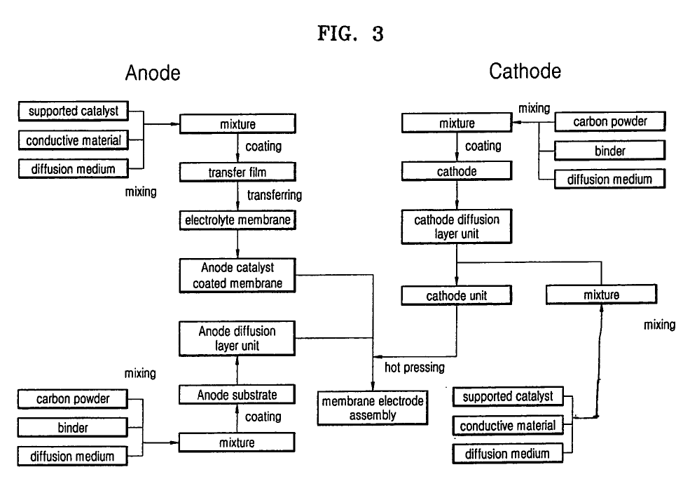

FIG. 3 is a flowchart illustrating a method of preparing a membrane electrode assembly according to an embodiment of the present invention. A method of preparing a membrane electrode assembly according to an embodiment of the present invention will now be described in detail with reference to FIG. 3.

Preparation of Anode Diffusion Layer Unit

An anode diffusion layer unit is formed by coating a mixture of a carbon powder, a binder, and a diffusion medium on an anode substrate and sintering the coated mixture.

The anode substrate can be formed of carbon paper. The anode diffusion layer can be formed using any method that can provide a diffusion layer having a uniform thickness on the anode substrate. For example, a carbon slurry can be prepared and coated on the anode substrate by tape casting, spraying, or screen printing. However, the method of forming the anode diffusion layer is not limited thereto.

The carbon slurry is a mixture of carbon powder, a binder, and a diffusion medium. As non-limiting examples, the carbon powder can be carbon black powder, acetylene black powder, carbon nanotube powder, carbon nanowire powder, carbon nanohorn powder, or carbon nanofiber powder.

The binder can be polytetrafluoroethylene (PTFE), polyvinylidenefluoride (PVdF), or fluorinated ethylene propylene (FEP), but is not limited thereto. The anode diffusion layer unit according to an embodiment of the present invention contains 5-20 wt % of polytetrafluoroethylene to obtain a hydrophilic property.

The diffusion medium can be water, ethanol, methanol, isopropylalcohol, n-propylalcohol, or butylalcohol, but is not limited thereto. Preferably, the diffusion medium is water, ethanol, methanol, or isopropylalcohol.

The carbon slurry may be prepared by mixing carbon slurry forming materials in a proper mixture ratio in a sonic bath for 30 minutes-2 hours.

The diffusion layer prepared as described above is sintered at a temperature of 150-350° C. for 30 minutes-2 hours. The sintering of the diffusion layer is performed to remove the diffusion medium and to properly disperse the binder so that a water repelling property is obtained and carbon loss is prevented. When the sintering temperature is lower than 150° C., the binder may be insufficiently dispersed so that the binding property may decrease and thus, the water repelling property may be low. On the other hand, when the sintering temperature is higher than 350° C., the diffusion layer unit may be deformed due to the excessively high temperature. When the sintering time is shorter than 30 minutes, the binder may be insufficiently dispersed so that the binding property may decrease and thus, the water repelling property may be low. On the other hand, if the sintering time is longer than 2 hours, the preparation process of the anode diffusion layer unit may be uneconomical, and the binder may be too uniformly dispersed, which can lead to low electrical conductivity.

The sintering temperature may be dependent on the kind of binder used. Particularly, the sintering temperature may be in the vicinity of the melting point of the binder used.

Preparation of Anode Catalyst Coated Membrane

An anode catalyst coated membrane is formed by coating a mixture of a supported catalyst, a conductive material, and a diffusion medium onto a transfer film, drying the coated mixture, and then transferring the dried film onto an electrolyte membrane.

As non-limiting examples, the transfer film can be Teflon film, polyethyleneterephthalate (PET) film, kaptone film, tedra film, aluminum foil, or mylar film. The conductive material may be a proton conductive resin, such as a fluorine resin having a water repelling property. Preferably, the conductive material is a fluorine resin having a melting point of 400° C. or lower, such as NAFION, polytetrafluoroethylene, or tetrafluoroethylene-perfluoro alkylvinyl ether copolymer. The amount of the binder used may be in the range of 10-40 parts by weight based on 100 parts by weight of a catalyst.

The catalyst can be, but is not limited to, Pt, Ru, Pd, Rh, Ir, Os, Pt, a mixture thereof, an alloy thereof, or a supported catalyst in which a metal thereof is supported by carbon black, acetylene black, activated carbon, or graphite. One of the supported catalysts can be PtRu/C.

As non-limiting examples, the diffusion medium can be water, 1-propanol, ethyleneglycol, or 2-propanol. The amount of diffusion medium used may be in the range of 5-250 parts by weight based on 100 parts by weight of the catalyst. For example, when the diffusion medium is water, the amount of water used may be in the range of 5-10 parts by weight; when the diffusion medium is 1-propanol, the amount of 1-propanol used may be in the range of 150-250 parts by weight; and when the diffusion medium is ethylene glycol, the amount of the ethylene glycol used may be in the range of 100-200 parts by weight; and when the diffusion medium is 2-propanol, the amount of 2-propanol used may be in the range of 150-250 parts by weight.

A method of coating a mixture of a supported catalyst, a conductive material, and a diffusion medium is not limited, and can be any method that can be used to form a catalyst layer having a uniform thickness on the transfer film. For example, a catalyst slurry can be prepared and coated onto the transfer film by tape casting, spraying, or screen printing. However, the coating method is not limited thereto.

The catalyst slurry may be prepared by mixing catalyst slurry-forming materials in a proper mixture ratio in a sonic bath for 1-3 hours.

The catalyst layer prepared as described above may be dried at 60-120° C. for 1-4 hours to remove the diffusion medium. When the drying temperature is lower than 60° C., the diffusion medium may be insufficiently removed and thus the catalyst layer may be insufficiently dried. On the other hand, when the drying temperature is higher than 120° C., the catalyst may be damaged. When the drying time is shorter than 1 hour, the diffusion medium may be insufficiently removed and thus the catalyst layer may be insufficiently dried. On the other hand, when the drying time is longer than 4 hours, the preparation process may be uneconomical.

As a result of drying of the catalyst layer, formation of an anode unit is complete. Subsequently, the anode unit is transferred onto an electrolyte membrane to form an anode catalyst coated membrane. The transferring of the anode unit can be performed using any method that is well known in the art. For example, the transferring method according to an aspect of the present embodiment may be a hot pressing method, but is not limited thereto.

The hot pressing can be performed at 100-140° C. at a pressure of 0.5-5 ton/cm² for 5-10 minutes. When the hot pressing temperature is lower than 100° C., the anode unit may be inadequately combined with the electrolyte membrane so that the interface resistance between the anode unit and the electrolyte membrane may be high. On the other hand, when the hot pressing temperature is higher than 140° C., the electrolyte membrane may be damaged due to dehydration.

In an embodiment of the present invention, by adjusting the temperature and pressure of the hot pressing within these ranges, the average diameter of the pores of the anode catalyst layer can be formed smaller than the average diameter of the pores of the cathode catalyst layer.

The transfer film attached to the anode unit may be removed after the hot pressing process is performed.

Cathode Diffusion Layer Unit

A cathode diffusion layer unit can be prepared in a similar manner to the anode diffusion layer unit. That is, a mixture of carbon powder, a binder, and a diffusion medium are coated on a cathode substrate and then sintered, and 20-50 wt % of polytetrafluoroethylene is used to obtain a hydrophobic property.

Preparation of Cathode Unit

A cathode unit is prepared in the same manner as the anode unit included in the anode catalyst coated membrane preparation process, except that a mixture of a supported catalyst, a conductive material, and a diffusion medium are directly coated on the cathode diffusion layer unit, not on the transfer film, and then dried.

Combination of Anode Diffusion Layer Unit, Anode Catalyst Coated Membrane and Cathode Unit

The anode diffusion layer unit, anode catalyst coated membrane and the cathode unit prepared are combined together by hot pressing, thereby forming a membrane electrode assembly according to an embodiment of the present invention.

The hot pressing can be performed at 100-140° C. at a pressure of 0.5-2 ton/cm² for 5 minutes-10 minutes. When the hot pressing temperature is lower than 100° C., the hot pressing may be inadequate so that the catalyst layer unit and the diffusion layer unit may become separated too easily. When the hot pressing temperature is higher than 140° C., the catalyst may be damaged.

Particularly, by adjusting the temperature and pressure of the hot pressing within these ranges, the average diameter of the pores of the cathode catalyst layer can be formed larger than the average diameter of the pores of the anode catalyst layer. In addition, the anode is twice subjected to the hot pressing process for transferring and combination, but the cathode is just subjected once to the hot pressing process. As a result, the average diameter of pores of the anode is smaller than the average diameter of pores of the cathode.

In an embodiment of the present invention, the average diameter of the pores of the anode catalyst layer is adjusted using a transfer film. During the pressing, pressure can be effectively transferred to the anode catalyst layer so that a desired pore size can be obtained because the transfer film is less deformed by pressure than carbon paper used to form the cathode. In addition, by finely adjusting the pressure of the hot pressing, the pore size can be controlled. On the other hand, when the cathode catalyst layer uses carbon paper as a catalyst coating, the carbon paper absorbs the pressure during the hot pressing so that high pressure cannot be applied to the catalyst layer, and thus, the cathode is formed having larger pores than the anode. Accordingly, the pressure created by a hot presser used to prepare an anode catalyst coated membrane is greater than the pressure created by a hot presser used to combine the anode catalyst coated membrane and a cathode unit. Since the anode catalyst coated membrane is prepared under such high pressure, pores of an anode catalyst layer formed under high pressure can be maintained when being subjected to a second hot pressing process.

The average diameter of the pores of the anode catalyst layer prepared may be in the range of 3-5 nm, and the average diameter of the pores of a cathode catalyst layer may be in the range of 10-50 nm.

The surface area per weight of the anode catalyst layer may be in the range of 15-25 m²/g, and the surface area per weight of the cathode catalyst layer may be in the range of 2-10 m²/g. When the surface area per weight of the anode catalyst layer is higher than 25 m²/g, the mechanical strength of the catalyst layer may be insufficient, whereas when the surface area per weight of the catalyst layer is lower than 2 m²/g, the diffusion of reactants may be badly affected.

A fuel cell including a membrane electrode assembly according to an embodiment of the present invention has a stacked structure of a plurality of unit cells, each of which includes the membrane electrode assembly (MEA) and a separator. In order to form a fuel cell system, a fuel processor (FP), a fuel tank, and a fuel pump may be further used.

Aspects of the present invention will be described in further detail with reference to the following examples. These examples are for illustrative purposes only and are not intended to limit the scope of the present invention.

Example 1

Carbon black powder, polytetrafluoroethylene, and isopropylalcohol were mixed in a weight ratio of 100: 5: 500 in a sonic bath for 2 hours, thereby preparing an anode diffusion layer slurry. The prepared anode diffusion layer slurry was coated onto 400 nm-thick carbon paper (GDL 10 series, SGL carbon group) and sintered at 170° C. for one hour, thereby preparing an anode diffusion layer unit.

PtRu black, used as an anode catalyst, was mixed with water, NAFION, and isopropylalcohol in a weight ratio of 10: 15: 200 based on 100 parts by weight of the anode catalyst in a sonic bath for two hours, thereby preparing an anode catalyst layer slurry. The prepared anode catalyst layer slurry was coated onto a PET film by screen printing and then dried at 70° C. for 2 hours, thereby preparing an anode unit, which was transferred onto an electrolyte membrane (NAFION 115 membrane produced by Dupont Co.) The anode unit was transferred to the electrolyte membrane by hot pressing at 130° C. at a pressure of 5 ton/cm² for 6 minutes, thereby preparing an anode catalyst coated membrane.

Meanwhile, carbon black powder, polytetrafluoroethylene, and isopropylalcohol were mixed in a weight ratio of 100: 20: 500 in a sonic bath for 2 hours, thereby preparing a cathode diffusion layer slurry. The prepared cathode diffusion layer slurry was coated onto 400 nm-thick carbon paper (GDL 10 series, SGL carbon group) and sintered at 350° C. for one hour, thereby preparing a cathode diffusion layer unit.

Pt black, used as a cathode catalyst, was mixed with water, NAFION, and isopropylalcohol in a weight ratio of 10: 15: 200 based on 100 parts by weight of a catalyst in a sonic bath for 2 hours, thereby preparing a cathode catalyst layer slurry. The prepared slurry was coated on the cathode diffusion layer unit and then dried, thereby preparing a cathode unit.

The anode diffusion layer unit, anode catalyst coated membrane and the cathode unit were hot pressed at 130° C. at a pressure of 2 ton/cm² for 5 minutes, thereby preparing a membrane electrode assembly.

In the prepared membrane electrode assembly of Example 1, the average diameter of pores of an anode catalyst layer was 3 nm and the average diameter of pores of a cathode catalyst layer was 30 nm.

Comparative Example 1

Carbon black powder, polytetrafluoroethylene, and isopropylalcohol were mixed in a weight ratio of 100: 20: 500 in a sonic bath for 2 hours, thereby preparing a cathode diffusion layer slurry. The prepared cathode diffusion layer slurry was coated onto 400 nm-thick carbon paper (GDL 10 series, SGL carbon group) and sintered at 350° C. for one hour, thereby preparing a cathode diffusion layer unit.

Pt black, used as a cathode catalyst, was mixed with water, NAFION, and isopropylalcohol in a weight ratio of 10: 15: 200 based on 100 parts by weight of a catalyst in a sonic bath for two hours, thereby preparing a cathode catalyst layer slurry. The prepared cathode catalyst layer slurry was coated onto a PET film by screen printing and then dried at 70° C. for 2 hours, thereby preparing a cathode unit, which was transferred onto an electrolyte membrane (NAFION 115 membrane produced by DuPont). The cathode unit was transferred to an electrolyte membrane by hot pressing at 130° C. at a pressure of 5 ton/cm² for 6 minutes, thereby preparing a cathode catalyst coated membrane.

Meanwhile, carbon black powder, polytetrafluoroethylene, and isopropylalcohol were mixed in a weight ratio of 100: 5: 500 in a sonic bath for 2 hours, thereby preparing an anode diffusion layer slurry. The prepared anode diffusion layer slurry was coated onto 400 nm-thick carbon paper (GDL 10 series, SGL carbon group) and sintered at 170° C. for one hour, thereby preparing an anode diffusion layer unit.

PtRu black, used as an anode catalyst, was mixed with water, NAFION, and isopropylalcohol in a weight ratio of 10: 15: 200 based on 100 parts by weight of the anode catalyst in a sonic bath for 2 hours, thereby preparing an anode catalyst layer slurry. The prepared slurry was coated onto the anode diffusion layer unit and then dried, thereby preparing an anode unit.

The cathode catalyst coated membrane and the anode unit were hot pressed at 130° C. at a pressure of 2 ton/cm² for 5 minutes, thereby preparing a membrane electrode assembly.

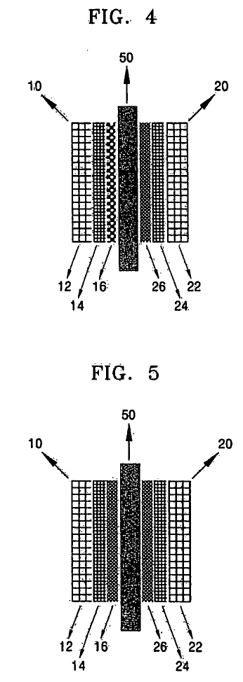

In the prepared membrane electrode assembly of Comparative Example 1, the average diameter of pores of an anode catalyst layer was 30 nm and the average diameter of pores of a cathode catalyst layer was 3 nm. A schematic sectional view of the membrane electrode assembly prepared according to Comparative Example 1 is illustrated in FIG. 4.

Comparative Example 2

Carbon black powder, polytetrafluoroethylene, and isopropylalcohol were mixed in a weight ratio of 100: 5: 500 in a sonic bath for 2 hours, thereby preparing an anode diffusion layer slurry. The prepared anode diffusion layer slurry was coated onto 400 nm-thick carbon paper (GDL 10 series, SGL carbon group) and sintered at 350° C. for one hour, thereby preparing an anode diffusion layer unit.

PtRu black, used as an anode catalyst, was mixed with water, NAFION, and isopropylalcohol in a weight ratio of 10: 15: 200 based on 100 parts by weight of the anode catalyst in a sonic bath for two hours, thereby preparing an anode catalyst layer slurry. The prepared anode catalyst layer slurry was coated onto a PET film by screen printing and then dried at 70° C. for 2 hours, thereby preparing an anode unit, which was to be transferred onto an electrolyte membrane.

Meanwhile, carbon black powder, polytetrafluoroethylene, and isopropylalcohol were mixed in a weight ratio of 100: 20: 500 in a sonic bath for 2 hours, thereby preparing a cathode diffusion layer slurry. The prepared cathode diffusion layer slurry was coated onto 400 nm-thick carbon paper (GDL 10 series, SGL carbon group) and sintered at 350° C. for one hour, thereby preparing a cathode diffusion layer unit.

Pt black, used as a cathode catalyst, was mixed with water, NAFION, and isopropylalcohol in a weight ratio of 10: 15: 200 based on 100 parts by weight of a catalyst in a sonic bath for 2 hours, thereby preparing a cathode catalyst layer slurry. The prepared slurry was coated onto a PET film by screen printing and then dried at 70° C. for 2 hours, thereby preparing a cathode unit to be transferred onto an electrolyte membrane.

An electrolyte membrane (NAFION 115 membrane produced by DuPont Co.) was interposed between the anode unit and the cathode unit, and the resultant structure was hot pressed at 130° C. at a pressure of 5 ton/cm² for 6 minutes so that the anode and the cathode were transferred to two opposite sides of the electrolyte membrane, thereby preparing a catalyst coated membrane.

The catalyst coated membrane was interposed between the anode diffusion layer unit and the cathode diffusion layer unit, and the resultant structure was hot pressed at 130° C. at a pressure of 2 ton/cm² for 5 minutes, thereby preparing a membrane electrode assembly.

In the prepared membrane electrode assembly of comparative example 2, the average diameter of pores of an anode catalyst layer was 3 nm and the average diameter of pores of a cathode catalyst layer was 3 nm. A schematic sectional view of a membrane electrode assembly prepared according to Comparative Example 2 is illustrated in FIG. 5.

Performance Comparison

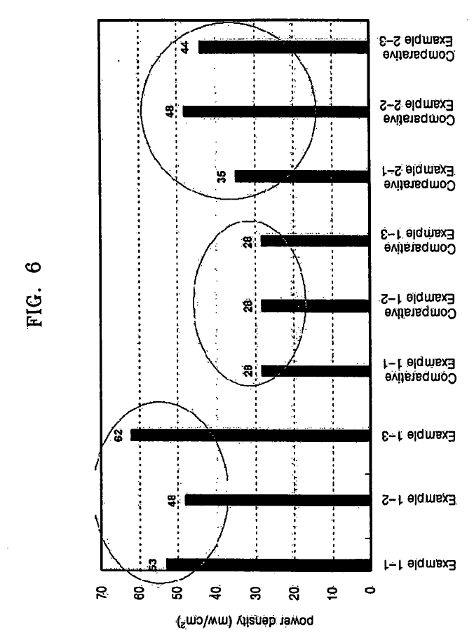

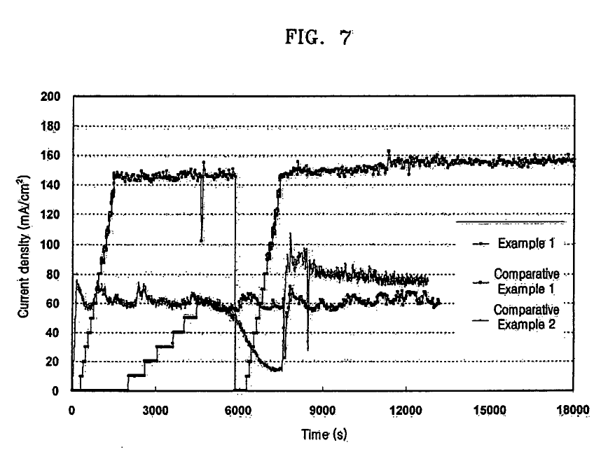

Unit cells including membrane electrode assemblies prepared according to Example 1, Comparative Example 1, and Comparative Example 2 were manufactured using conventional methods that are known in the art. Altogether, three unit cells were manufactured for each membrane electrode assembly. Power density and current density with respect to time of the prepared unit cells were measured. The results (average value of three samples) are shown in FIGS. 6 and 7.

FIG. 6 is a graph of power density with respect to time of unit cells using the membrane electrode assemblies prepared according to Example 1 and Comparative Examples 1 and 2. Referring to FIG. 6, the average power density of the three unit cells manufactured according to Example 1 was 55 mW/cm², which is much higher than the average power densities of the three unit cells manufactured according to Comparative Example 1 and Comparative Example 2, which were 28 mW/cm² and 42 mW/cm², respectively.

FIG. 7 is a graph of current density with respect to time of unit cells using the membrane electrode assemblies prepared according to Example 1 and Comparative Examples 1 and 2. Referring to FIG. 7, the performance of a unit cell including the membrane electrode assembly prepared according to Example 1 decreased by 5% over a unit time, whereas the performance of unit cells including the membrane electrode assemblies prepared according to Comparative Example 1 and Comparative Example 2 decreased by 50% or more, and by 15% over the same unit time, respectively. That is, the unit cell including the membrane electrode assembly prepared according to Example 1 showed excellent durability compared to unit cells including membrane electrode assemblies according to Comparative Examples 1 and 2.

According to aspects of the present invention, a membrane electrode assembly is provided in which air can easily supplied to a cathode and water can easily flow out of a cathode, thereby obtaining high performance of a fuel cell; and in which an anode catalyst layer has relatively small pores, thereby obtaining high durability of an anode and reducing the diffusion speed of methanol in the anode catalyst layer in order to maintain the initial performance of a battery for a long time. In addition, a method of preparing the membrane electrode assembly and a fuel cell including the membrane electrode assembly are provided.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A membrane electrode assembly comprising:
an anode comprising an anode substrate, an anode diffusion layer, and an anode catalyst layer having pores;
a cathode comprising a cathode substrate, a cathode diffusion layer, and a cathode catalyst layer having pores; and
an electrolyte membrane interposed between the cathode and the anode,
wherein the anode diffusion layer is hydrophilic and the cathode diffusion layer is hydrophobic, and the average diameter of the pores of the anode catalyst layer is smaller than the average diameter of the pores of the cathode catalyst layer.

2. The membrane electrode assembly of claim 1, wherein the anode diffusion layer comprises 5-20 wt % of polytetrafluoroethylene.

3. The membrane electrode assembly of claim 1, wherein the cathode diffusion layer comprises 20-50 wt % of polytetrafluoroethylene.

4. The membrane electrode assembly of claim 2, wherein the cathode diffusion layer comprises 20-50 wt % of polytetrafluoroethylene.

5. The membrane electrode assembly of claim 1, wherein the average diameter of the pores of the anode catalyst layer is in the range of 3-5 nm.

6. The membrane electrode assembly of claim 1, wherein the average diameter of the pores of the cathode catalyst layer is in the range of 10-50 nm.

7. The membrane electrode assembly of claim 5, wherein the average diameter of the pores of the cathode catalyst layer is in the range of 10-50 nm.

8. The membrane electrode assembly of claim 1, wherein the anode catalyst layer has a surface area per weight of 15-25 m²/g.

9. The membrane electrode assembly of claim 1, wherein the cathode catalyst layer has a surface area per weight of 2-10 m²/g.

10. The membrane electrode assembly of claim 8, wherein the cathode catalyst layer has a surface area per weight of 2-10 m²/g.

11. A method of preparing a membrane electrode assembly, the method comprising:
preparing an anode diffusion layer unit by coating a mixture of a carbon powder, a binder, and a diffusion medium on an anode substrate and sintering the coated mixture;
preparing an anode catalyst coated membrane by coating a mixture of a supported catalyst, a conductive material, and a diffusion medium on a transfer film, drying the coated mixture, and transferring the dried mixture onto an electrolyte membrane;
preparing a cathode diffusion layer unit by coating a mixture of a carbon powder, a binder, and a diffusion medium on a cathode substrate and sintering the resultant coated mixture;
preparing a cathode unit by coating a mixture of a supported catalyst, a conductive material, and a diffusion medium on the cathode diffusion layer unit and drying the coated mixture; and
hot pressing the anode diffusion layer unit, anode catalyst coated membrane and the cathode unit together to form the membrane electrode assembly.

12. The method of claim 11, wherein, in preparing an anode diffusion layer unit by coating a mixture of a carbon powder, a binder, and a diffusion medium on an anode substrate and in preparing a cathode diffusion layer unit by coating a mixture of a carbon powder, a binder, and a diffusion medium on a cathode substrate, the carbon powder is independently selected from carbon black powder, acetylene black powder, carbon nanotube powder, carbon nanowire powder, carbon nanohorn powder, and carbon nanofiber powder.

13. The method of claim 11, wherein the anode diffusion layer unit comprises 5-20 wt % of polytetrafluoroethylene.

14. The method of claim 11, wherein the cathode diffusion layer unit comprises 20-50 wt % of polytetrafluoroethylene.

15. The method of claim 11, wherein in the preparing of an anode catalyst coated membrane, the transferring is performed at a temperature of 100-140° C. at a pressure of 0.5-5 ton/cm² for 5-10 minutes by hot pressing.

16. The method of claim 11, wherein in the hot pressing of the anode diffusion layer unit, anode catalyst coated membrane and the cathode unit, the hot pressing is performed at a temperature of 100-140° C. at a pressure of 0.5-2 ton/cm² for 5-10 minutes.

17. The method of claim 11, wherein the formed membrane electrode assembly includes an anode catalyst layer and a cathode catalyst layer wherein an average diameter of the pores of the anode catalyst layer is smaller than an average diameter of the pores of the cathode catalyst layer.

18. The method of claim 17, wherein the average diameter of pores of the anode catalyst layer is controlled by performing the transferring in preparing the anode catalyst coated membrane by hot pressing and controlling a temperature and pressure of the hot pressing.

19. The method of claim 17, wherein the average diameter of pores of the cathode catalyst layer is controlled by including carbon paper in the cathode unit, wherein the carbon paper absorbs pressure in the cathode unit during the hot pressing of the anode diffusion layer unit, anode catalyst coated membrane and the cathode unit to form the membrane electrode assembly.

20. A fuel cell including the membrane electrode assembly of claim 1.
